(19) United States
(12) Patent Application Publication
(10) Pub. No.: US 2001/0027536 A1
(43) Pub. Date: Oct. 4, 2001

(54) Methods in a communication system

(76) Inventors: Jan Soderkvist, Osterangsvagen (SE); Anders Elfstrom, Bellmansgatan (SE)

Correspondence Address: Thomas L. Crisman, Esq., Jenkens and Gilchrist, P.C., 3200 Fountain Place, 1445 Ross Ave., Dallas, TX, 75202-2799, US

(21) Appl. No.: 09/792,210

(22) Filed: Feb. 23, 2001

(30) Foreign Application Priority Data
Mar. 17, 2000 (SE) SE0000897-9

(51) Int. Cl. H02H 3/05

(52) U.S. Cl. 714/18

(57) ABSTRACT

The invention relates to a method for transmitting data frames and a matching method for receiving data frames. According to the method for transmitting data frames, when retransmissions are necessary, modified data frames (S502) produced by applying a bit pattern modifying function (F1) to the originally transmitted data frames (S501) are transmitted. According to the method for receiving data frames, when data frames (S503) fail a first cyclic redundancy check, a second cyclic redundancy check is performed on modified data frames (S504) produced by applying the inverse (F2) of the bit pattern modifying function (F1) to the data frames (S504).

### TECHNICAL FIELD OF THE INVENTION

The invention relates to methods in a communication system. More in particular, the invention relates to a method for transmitting data frames and a matching method for receiving data frames in a communication system.

### DESCRIPTION OF RELATED ART

Cellular communication networks typically support a plurality of different communication services. The most commonly recognized and widely used communication service relates to handling voice communications to and from the mobile stations of cellular subscribers. Cellular networks may further support asynchronous data communications and facsimile communications.

Cellular networks utilize a number of different types of air interfaces, such as TIA/EIA-136, for handling radio frequency communications between the mobile stations and base stations of said networks.

The TIA/EIA-136 specification provides for communication of user data frames according to a protocol called radio link protocol 1 on a digital traffic channel established between a cellular network and a mobile station. The digital traffic channel also provides for communication of Fast Associated Control Channel (FACCH) system control information frames. When receiving frames transmitted on the digital traffic channel, discrimination between user data frames and FACCH system control information frames needs to be performed in order to determine how to process the received frames. Due to incorrect discrimination between user data frames and system control information frames, some user data frames may be lost in the discrimination process.

### SUMMARY OF THE INVENTION

The invention addresses the problem of providing a more robust way of communicating data frames in a communication system, in particular when there are data frames having bit patterns causing said data frames to exhibit an increased risk for getting lost.

The problem is essentially solved by a method for transmitting data frames, wherein when retransmissions are necessary, modified data frames produced by applying a bit pattern modifying function to the originally transmitted data frames are transmitted, and a matching method for receiving data frames, wherein when data frames fail a first cyclic redundancy check, a second cyclic redundancy check is performed on modified data frames produced by applying the inverse of the bit pattern modifying function to the data frames.

More specifically, the problem is solved by using a method of transmitting data frames according to claim 1 and using a method of receiving data frames according to claim 8.

A general object of the invention is to provide a more robust way of communicating data frames in a communication system, in particular when there are data frames having bit patterns causing said data frames to exhibit an increased risk for getting lost.

A more specific object of some embodiments of the invention is to provide an increased robustness against incorrect discrimination of user data frames and system control information frames transported on a bidirectional digital traffic channel between a mobile station and a radio communication network.

A general advantage of the invention is that it affords a more robust way of communicating data frames in a communication system, in particular when there are data frames having bit patterns causing said data frames to exhibit an increased risk for getting lost.

A more specific advantage of some embodiments of the invention, is that they afford an increased robustness against incorrect discrimination of user data and system control information transported on a bidirectional digital traffic channel between a mobile station and a radio communication network.

The invention will now be described in more detail with reference to exemplary embodiments thereof and also with reference to the accompanying drawings.

### BRIEF DESCRIPTION OF THE DRAWINGS

FIG. 1 is a view illustrating a communication system.

FIG. 2 is a schematic block diagram illustrating more details of some of the elements included in the communication system introduced in FIG. 1.

FIG. 3 is a schematic block diagram illustrating the structure of a RLP1 protocol handler.

FIG. 4A is a flow chart illustrating a first exemplary embodiment of a method for transmitting data frames according to the invention.

FIG. 4B is a flow chart illustrating a first exemplary embodiment of a method for receiving data frames according to the invention.

FIG. 5A is a block diagram illustrating a first user data frame and a modified first user data frame.

FIG. 5B is a block diagram illustrating a second user data frame and a modified second user data frame.

### DETAILED DESCRIPTION OF THE EMBODIMENTS

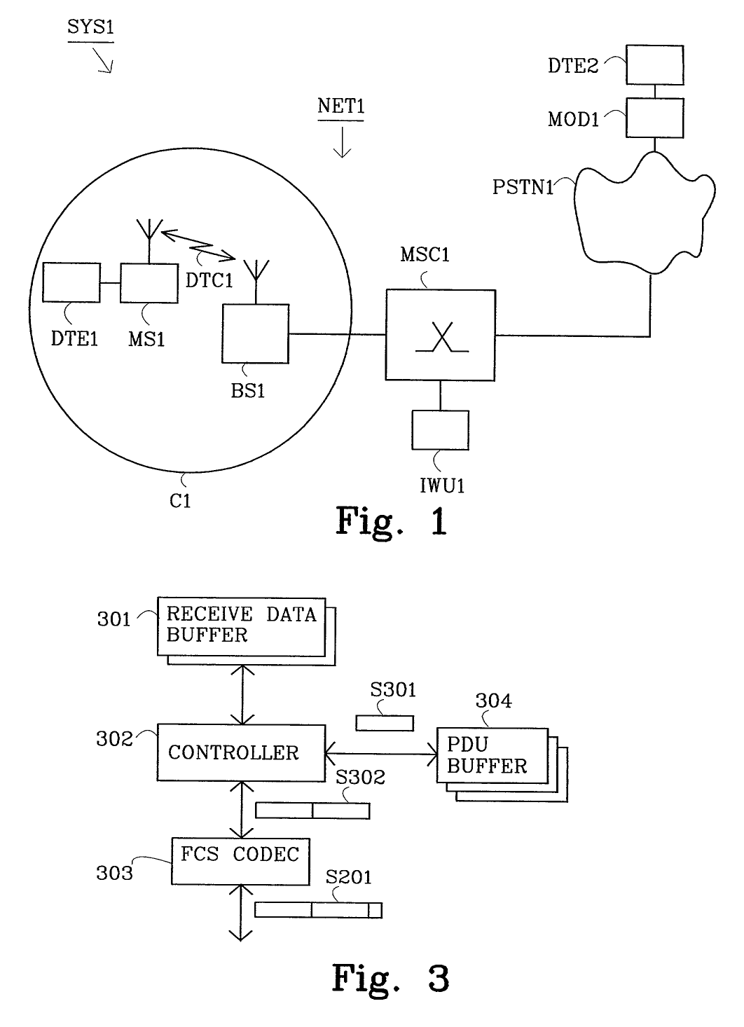

FIG. 1 illustrates one exemplary embodiment of a communication system SYS1 in which the present invention is applied.

The communication system SYS1 comprises a radio communication portion and a wireline communication portion. The radio communication portion comprises a radio communication network NET1, a first mobile station MS1 and a first data terminating equipment DTE1 (e.g. a laptop computer) connected to the mobile station MS1. The wireline communication portion comprises a telephone network PSTN1, a first modem MOD1 and a second data terminating equipment DTE2 (e.g. a personal computer) connected to the modem MOD1. The communication system SYS1 provides a number of communication services, including data communication and facsimile services, to its users. Thus, users of the first data terminating equipment DTE1 and the second data terminating equipment DTE2 may communicate with each other by e.g. sending facsimiles, emails or performing file transfers.

The radio communication network NET1 comprises a mobile switching centre MSC1, an interworking unit IWU1 and base stations, including a first base station BS1, connected to the mobile switching centre MSC1. The base stations provide radio coverage in a geographical area served by the mobile switching centre MSC1. The mobile switching centre MSC1 is responsible for switching calls to and from mobile stations located in the geographical area served by the mobile switching centre MSC1. The interworking unit IWU1 provides interworking functions necessary for handling data/facsimile calls destined to or originating from mobile stations located in the geographical area served by the mobile switching centre MSC1. The geographical area is divided into a number of cells, including cell C1. In each cell radio coverage is provided by one of the base stations. The cell C1 in which the first mobile station MS1 is currently located is denoted the serving cell and the corresponding base station BS1 is denoted the serving base station. In the exemplary communication system SYSI illustrated in FIG. 1, communication between the radio communication network NET1 and the first mobile station MS1 is based on the TIA/EIA-136 interface specifications. Support for data/facsimile calls are provided according to the TIA/EIA-136-350 and TIA/EIA-136-310 specifications. Note that in FIG. 1 only elements necessary for illustrating the present invention are illustrated and that typically a radio communication network comprises several mobile switching centres, a greater number of base stations as well as other types of nodes such as home location registers and serves a large number of mobile stations.

A set of bidirectional radio frequency channels are allocated to the serving cell C1 for communication between the base station BS1 and mobile stations, e.g. the first mobile station MS1, operating within the cell C1. Each radio frequency channel consists of a pair of separate radio frequencies, one for communication in the downlink direction, i.e. from the serving base station BS1 to mobile stations, and one for communication in the uplink direction, i.e. from mobile stations to the serving base station BS1.

Using a time division multiple access (TDMA) scheme, physical channels are defined in TIA/EIA-136 by dividing a radio frequency channel into a series of repeating time slots organized in TDMA-frames and assigning the time slots to different physical channels. Each TDMA-frame consists of 6 time slots which can be used to support three full rate channels, by assigning two time slots to each full rate channel, or six half rate channels, by assigning one time slot to each half rate channel, on a single radio frequency channel. Communication on a physical channel occurs by transmitting bursts of digital data as digitally modulated radio signals in the form of short sequences of radio symbols on the radio frequency channel in the time slots assigned to the physical channel.

The physical channels can either be used as digital traffic channels (DTC) or as digital control channels (DCCH). The digital control channels are used primarily for transmission of system control information between a base station and one or a plurality of mobile stations operating within a cell served by the base station. The digital traffic channels are used for transmission of voice or user data traffic as well as system control information between a base station and a specific mobile station during a call. FIG. 1 illustrates how the first mobile station MS1 and the serving base station BS1 communicates during a call using a first digital traffic channel DTC1.

System control information is transmitted both on a slow associated control channel (SACCH) portion and a fast associated control channel (FACCH) portion of the first digital traffic channel DTC1. Control information is transmitted on the slow associated control channel in 12 dedicated bits included in each burst transmitted on the first digital traffic channel DTC1 while control information transmitted on the fast associated control channel replaces voice or user data in the transmitted bursts whenever system considerations deem it appropriate to do so. Thus, the fast associated control channel is a so called “blank and burst channel”. The TIA/EIA-136 specifications provide no explicit indication whether a burst is used for transmitting voice/user data or for transmitting system control information on the fast associated control channel.

One way of discriminating between voice/user data and FACCH system control information is as follows. Sets of received radio symbols are first processed according to the rules for decoding FACCH system control information specified in the TIA/EIA-136 specifications so as to produce FACCH system control information frames. Cyclic redundancy checks are then performed of the FACCH system control information frames according to the rules for FACCH system control information. If a FACCH system control information frame passed the cyclic redundancy check, the corresponding set of received radio symbols is considered to be conveying a FACCH system control information frame, while if the FACCH system control information frame failed the cyclic redundancy check, the corresponding set of received radio symbols is considered to be conveying a voice/user data frame.

Unfortunately it turns out that if sets of radio symbols corresponding to voice/user data frames having certain bit pattern combinations are processed according to the rules for decoding FACCH system control information, the result of said processing will be blocks of data bits which passes cyclic redundancy checks according to the rules for FACCH system control information. Thus, this method of discriminating between voice/user data and FACCH system control information provides a small but non-zero probability that, even in the absence of any bit errors introduced during radio transmission, a voice/user data frame will be interpreted as a FACCH system control information frame at the receiving end and thus will not be treated as a voice/user data frame. In practice, this is not a problem for voice frames. It may however be a problem when transferring user data frames since if one of the user data frames in a user data transfer transaction, e.g. a file transfer, has a bit pattern causing it to be mistakenly treated as a FACCH system control information frame, it will be impossible to complete the data transfer transaction. Note that retransmitting said user data frame provides no remedy of the situation.

The present invention provides a way of significantly decreasing the risk that a user data transfer transaction cannot be completed due to erronously discrimination between user data frames and FACCH system control information frames at the receiving end.

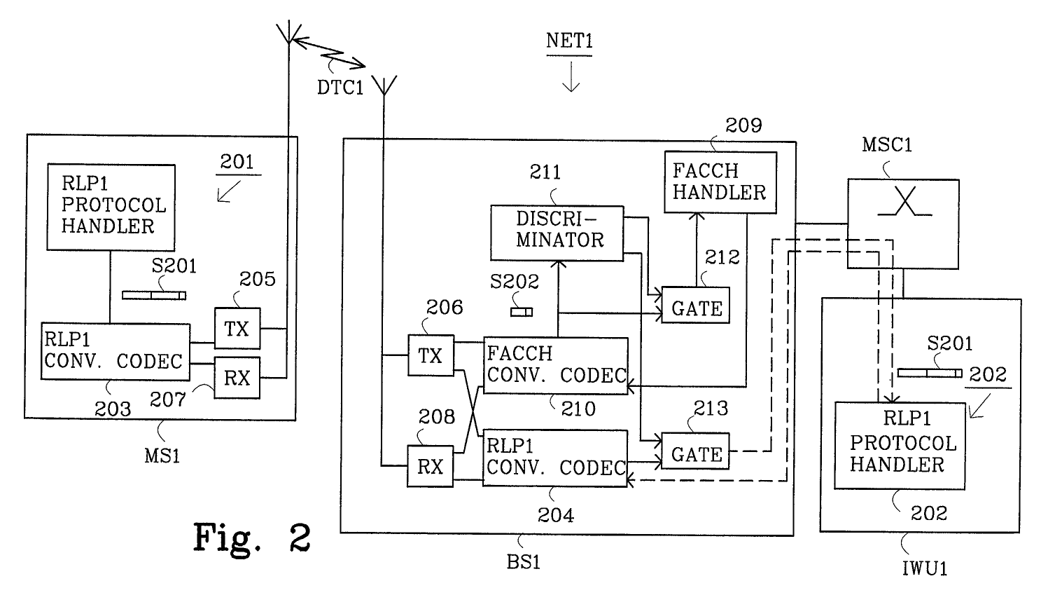

FIG. 2 illustrates schematically more details of parts of the communication system SYS1 in FIG. 1 which are of particular relevance to the present invention, i.e. the first mobile station MS1, the serving base station BS1 and the interworking unit IWU1.

For communication of user data between the mobile station MS1 and the radio communication network NET1, the Radio Link Protocol 1 (RLP1) specified in TIA/EIA-136-310 is used. All RLP1 specific functions except convolutional coding/decoding are handled by a first RLP1 protocol handler 201 associated with and integrated in the first mobile station MS1 and a second RLP1 protocol handler 202 associated with the radio communication network NET1 and integrated in the interworking unit IWU1.

The first mobile station MS1 includes a first RLP1 convolutional codec 203 connected to the first RLP1 protocol handler 201 and the serving base station BS1 includes a second RLP1 convolutional codec 204 connected via the mobile switching centre MSC1 to the second RLP1 protocol handler 202 in the interworking unit IWU1. The RLP1 convolutional codecs 203-204 perform ⅚-rate convolutional encoding and decoding according to the TIA/EIA-136-310 specifications.

The first mobile station MS1 further includes a first radio transmitter block 205 and a first radio receiver block 207 while the serving base station BS1 includes a second radio transmitter block 206 and a second radio receiver block 208. The radio transmitter blocks 205-206 perform interleaving, burst generation, RF modulation and power amplification in accordance with the TIA/EIA-136 specifications while the radio receiver blocks 207-208 perform demodulation, symbol detection and deinterleaving in accordance with the TIA/EIA-136 specification.

FIG. 2 further illustrates that the serving base station BS1 includes a FACCH handler 209 and a FACCH convolutional codec 210. The FACCH handler 209 generates FACCH messages for transmission to the first mobile station MS1 and analyses FACCH messages received from the first mobile station MS1. The FACCH convolutional codec 210 performs ¼-rate convolutional encoding and decoding as specified in the TIA/EIA-136 specifications for FACCH system control information. Both the RLP1 convolutional codec 204 and the FACCH convolutional codec 210 are connected to the second transmitter block 206 and the second receiver block 208 of the serving base station BS1, enabling the serving base station BS1 to communicate on the first digital traffic channel DTC1 by transmitting and receiving both FACCH system control information and RLP1 formatted user data.

The serving base station BS1 also includes a discriminator 211, a first gate 212 and a second gate 213. The first gate 212 is connected in between the FACCH convolutional codec 210 and the FACCH handler 209 while the second gate 213 is connected in between the second RLP1 convolutional codec 204 in the serving base station BS1 and the second RLP1 protocol handler 202 in the interworking unit IWU1. The discriminator 211 is connected to both the FACCH convolutional codec 210 and the first and second gates 212-213. The discriminator 211 determines, based on output data from the FACCH convolutional codec 210, whether a set of radio symbols received on the digital traffic channel DTC1 by the serving base station BS1 from the first mobile station MS1 is to be treated as conveying FACCH system control information or RLP1 user data and orders the first and second gates 212-213 to forward/discard the corresponding output data from the FACCH convolutional codec 210 and the second RLP1 convolutional codec 204 accordingly.

Note that even though FIG. 2 does not illustrate blocks in the first mobile station MS1 corresponding to blocks 209-213 in the first base station BS1, the first mobile station MS1 does include blocks performing the corresponding functions.

When transmitting user data using the RLP1 protocol, each RLP1 protocol handler 201-202 generates user data frames S201, i.e. so called RLP1 frames, and delivers the generated user data frames S201 to the respective RLP1 convolutional codec 203-204. Each user data frame S201 contains 216 bits. The RLP1 convolutional codecs 203-204 generate so called RLP1 Encoded frames by performing ⅚-rate convolutional encoding of the user data frames S201 received from the respective RLP1 protocol handler 201-202. Each RLP1 Encoded frame contains 260 bits. The RLP1 Encoded frames are delivered to the respective transmitter block 205-206 for transmission on the first digital traffic channel DTC1.

When transmitting FACCH system control information from the serving base station BS1, the FACCH handler 209 generates system control information frames S202, i.e. so called FACCH message words, and delivers the system control information frames to the FACCH convolutional codec 210. Each system control information frame S202 contains 65 bits. The FACCH convolutional codec 210 performs ¼-rate convolutional encoding of the system control information frames S202 producing convolutional coded data blocks, each containing 260 bits, which are delivered to the second transmitter block 206 for transmission on the first digital traffic channel DTC1.

When the serving base station BS1 receives radio symbols transmitted by the first mobile station MS1 on the first digital traffic channel DTC1, the second radio receiver block 208 generates output data blocks of 260 bits each, by performing demodulation, symbol detection and deinterleaving in accordance with the TIA/EIA-136 specification. Each block of output data generated by the second radio receiver block 208 corresponds to a certain set of received radio symbols. The blocks of output data from the second radio receiver block 208 are provided to both the FACCH convolutional codec 210 and the second RLP1 convolutional codec 204 which perform rate-¼ and rate-⅚ convolutional decoding respectively. Thus, the FACCH convolutional codec 210 generates a 65 bit system control information frame S202 and the second RLP1 convolutional codec 204 generates a 216 bit user data frame S201 for each block of output data from the second radio receiver block 208. The discriminator 211 receives the system control information frames S202 from the FACCH convolutional codec 210 and performs a cyclic redundancy check of each system control information frame S202 according to the rules for FACCH system control information. If the content of a system control information frame S202 passes the cyclic redundancy check, the discriminator 211 determines that a FACCH message word has been received and orders the first gate 212 to forward the system control information frame S202 to the FACCH handler 209 and orders the second gate 213 to discard the corresponding user data frame S201 generated by the second RLP1 convolutional codec 204. If the content of the system control information frame S202 fails the cyclic redundancy check, the discriminator 211 determines that a RLP1 Frame has been received and orders the second gate 213 to forward the corresponding user data frame S201 to the second RLP1 protocol handler 202 via the mobile switching centre MSC1 and orders the first gate 212 to discard the system control information frame S202.

When the first mobile station MS1 transmits FACCH system control information and receives radio symbols transmitted by the serving base station BS1 on the first digital traffic channel DTC1, similar processing as described above for the serving base station BS1 are performed.

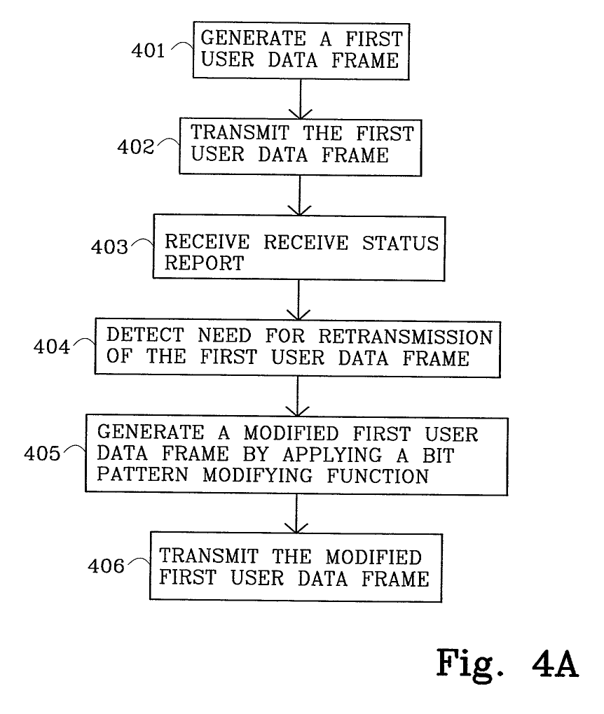

FIG. 3 illustrates more details of the internal structure of the RLP1 protocol handlers 201-202. Each RLP1 protocol handler 201-202 includes receive data buffers 301, a controller 302, a Frame Check Sequence (FCS) codec 303 and a set of protocol data unit (PDU) buffers 304. The receive data buffers 301 are used to buffer user data received from the peer RLP1 protocol handler. There are two receive data buffers 301, one for each service access point (SAP 0 and SAP 1). The controller 302 performs most of the RLP1 related functions including compression, blocking, transmission control, encryption, concatenation and layer management according to the RLP1 reference model in TIA/EIA-136-310. The controller 302 also handles interactions with higher layer functions corresponding to the layer-2 service primitives specified in TIA/EIA-136-310. The controller 302 generates RLP1 PDUs S301 for transmission to the peer RLP1 protocol handler. The controller 302 stores each generated RLP1 PDU S301 in a PDU-buffer 304 until that PDU has been acknowledged by the peer RLP1 protocol handler. The controller 302 delivers so called concatenated RLP1 PDUs S302, each comprising one or more generated RLP1 PDUs S301, to the FCS-codec 303 which calculates and adds a so called Cyclic Redundancy Check (CRC) to each concatenated RLP1 PDU S302 and thus produces so called RLP1 frames, i.e. user data frames S201. Data received from the peer RLP1 protocol handler is provided to the RLP1 protocol handler as user data frames S201. When a user data frame S201 is received by the RLP1 protocol handler, the FCS-codec 303 performs a cyclic redundancy check of the content of the received user data frame S201. If the cyclic redundancy check was successful, the FCS-codec 303 delivers the received concatenated RLP1 PDU S302 included in the received user data frame S201 to the controller 302 which processes the individual RLP1 PDUs S301 included in the received concatenated RLP1 PDU S302 according to the TIA/EIA-136-310 specifications. The TIA/EIA-136-310 specifications allows the higher layer functions to select the use of either a 16-bit or a 24-bit CRC in the RLP1/user data frames S201, and thus the FCS-codec 303 operates using either 16-bit or 24-bit CRCs.

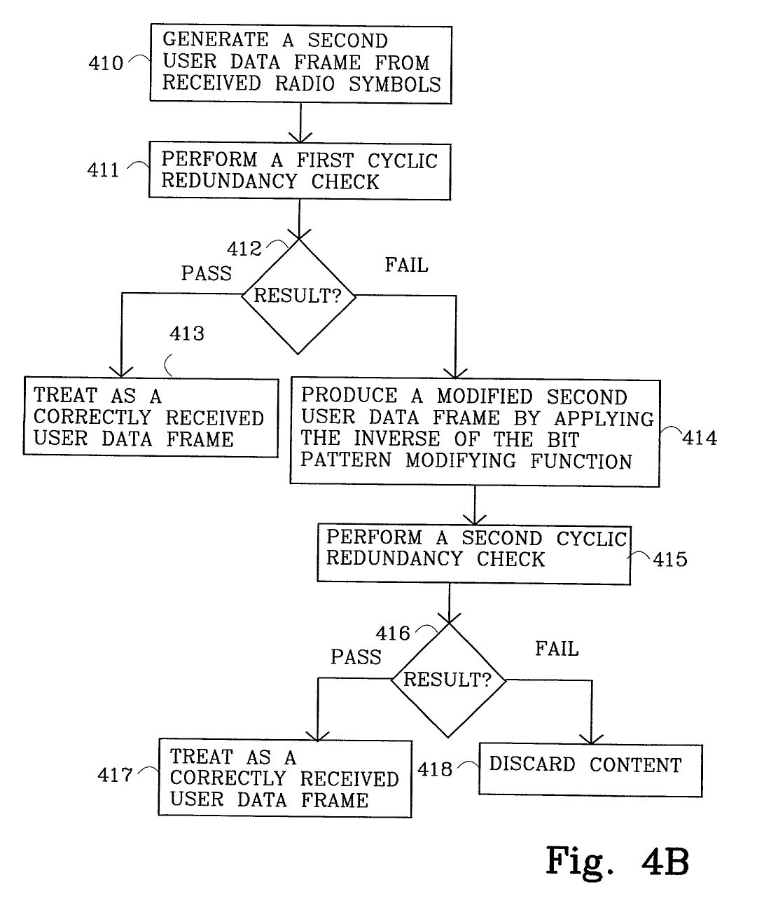

FIG. 4A-4B illustrate first exemplary embodiments of methods according to the invention for communicating user data between the first RLP1 protocol handler 201 in the first mobile station MS1 and the second RLP1 protocol handler 202 in the interworking unit IWU1. FIG. 4A illustrates steps performed in the first mobile station MS1 according to a first exemplary method of transmitting user data frames according to the invention. FIG. 4B illustrates steps performed in the radio communication network NET1 according to a first exemplary method for receiving user data frames according to the invention. Note that the methods are fully symmetrical, i.e. the method for transmitting user data frames illustrated in FIG. 4A could instead be performed in the radio communication network NET1 while the method for receiving user data frames illustrated in FIG. 4B could instead be performed in the first mobile station MS1.

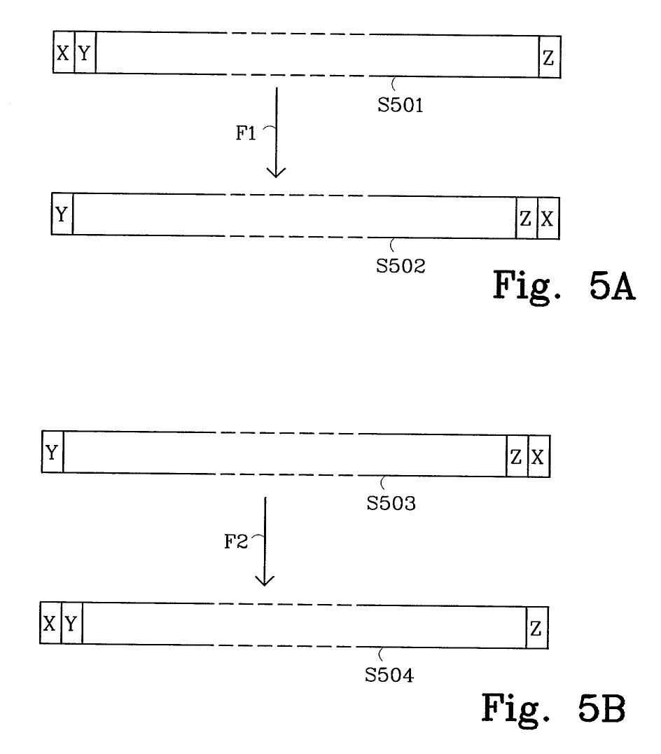

At step 401 in FIG. 4A, the first RLP1 protocol handler 201 generates a first user data frame as previously described in connection with FIG. 3. FIG. 5A illustrates the first user data frame S501.

At step 402, the first user data frame S501 is transmitted on the first digital traffic channel DTC1. This step includes generating a first set of radio symbols from the first user data frame S501 and transmitting the radio symbols on the first digital traffic channel DTC1 as previously described in connection with FIG. 2.

At step 403, the first RLP1 protocol handler 201 receives a report on the receive status from the second RLP1 protocol handler 202. The receive status are provided in RLP1 feedback PDUs, i.e. RLP1 Supervision or Long Supervision PDUs. The controller 302 in the first RLP1 protocol handler 201 (see FIG. 3) compares the receive status reported with the content of the PDU buffers 304. Stored RLP1 PDUs which are acknowledged as received by the second RLP1 protocol handler 202 are removed from the PDU buffers 304 by the controller 302. The controller 302 also notes if there are RLP1 PDUs stored in the PDU buffers 304, which are not acknowledged as received by the second RLP1 protocol handler 202 and initiates retransmission of such PDUs.

Thus, assuming that the at least one RLP1 PDU included in the first user data frame was not reported as received in the receive status report, the controller 302 detects a need for retransmission of the first user data frame S501 at step 404 and proceeds by supplying the FCS-codec 303 with the concatenated PDU portion of the first user data frame S501 and instructing the FCS-codec 303 to generate a modified first user data frame for transmission to the second RLP1 protocol handler 202. The modified first user data frame S502 is illustrated in FIG. 5A.

At step 405 the FCS-codec 303 generates the modified first user data frame S502 by first regenerating the first user data frame S501, i.e. calculating and adding a CRC to the concatenated PDU portion, and then applying a predetermined bit pattern modifying function F1 to the content of the regenerated first user data frame. In this exemplary embodiment of the invention, the bit pattern modifying function F1 used by the FCS-codec 303 produces the modified first user data frame by performing a cyclic one bit position left shift of the regenerated first user data frame. Thus, as illustrated in FIG. 5A, the content X of the first bit position of the first user data frame S501 is moved to the last bitposition in the modified first user data frame S502 while the content of all other bit positions in the first user data frame S501, represented as Y-Z in FIG. 5A, is moved one bit position to the left in the modified first user data frame S502.

At step 406 the modified first user data frame S502 is transmitted on the first digital traffic channel DTC1 by generating a second set of radio symbols from the modified first user data frame S502 and transmitting the radio symbols on the first digital traffic channel DTC1 as previously described in connection with FIG. 2.

At step 410 in FIG. 4B, a second user data frame is generated in the serving base station BS1 from a set of radio symbols received on the first digital traffic channel DTC1 as previously described in connection with FIG. 2, i.e. the second user data frame is generated by performing demodulation, symbol detection, deinterleaving and rate-⅚ convolutional decoding. A system control information frame is also generated from the same set of radio symbols and provided to the discriminator 211, which determines that a RLP1 Frame has been received and orders the second gate 213 to forward the second user data frame to the second RLP1 protocol handler 202. FIG. 5B illustrates the second user data frame S503.

At step 411, the FCS-codec 303 in the second RLP1 protocol handler 202 receives the second user data frame S503 and performs a first cyclic redundancy check of the second user data frame S503.

At step 412, the FCS-codec 303 evaluates the result of the first cyclic redundancy check.

If the second user data frame S503 passed the first cyclic redundancy check (a result PASS at step 412), the FCS-codec 303 proceeds at step 413 by treating the second user data frame as a correctly received user data frame, i.e. the FCS-codec delivers the concatenated RLP1 PDU received in the second user data frame to the controller 302 for further processing.

If the second user data frame S503 failed the first cyclic redundancy check (a result FAIL at step 412), the FCS-codec 303 proceeds at step 414 by producing a modified second user data frame by applying the inverse of the bit pattern modifying function used at step 405 in FIG. 4A to the content of the second user data frame. Thus, as illustrated in FIG. 5B, in this exemplary embodiment of the invention, the inverse function F2 used by the FCS-codec produces the modified second user data frame S504 by performing a cyclic one bit position right shift of the second user data frame S503, i.e. the content X of the the last bit position of the second user data frame S503 is moved to the first bit position in the modified second user data frame S504, while the contents of all other bit positions in the second user data frame S503, represented as Y-Z in FIG. 5B, are moved one bit position to the right in the modified second user data frame S504.

At step 415, the FCS-codec 303 performs a second cyclic redundancy check of the modified second user data frame S504.

At step 416, the FCS-codec 303 evaluates the result of the second cyclic redundancy check.

If the modified second user data frame S504 passed the second cyclic redundancy check (a result PASS at step 416), the FCS-codec 303 proceeds at step 417 by treating the modified second user data frame S504 as a correctly received user data frame, i.e. the FCS-codec 303 delivers the concatenated RLP1 PDU received in the modified second user data frame S504 to the controller 302 for further processing.

If the modified second user data frame S504 failed the second cyclic redundancy check (a result FAIL at step 416), the FCS-codec 303 proceeds at step 418 by discarding the content of the modified second user data frame S504.

Assuming that the user data frames communicated between the first RLP1 protocol data handler 201 and the second RLP1 protocol handler each consists of a 25 byte long concatenated PDU, i.e. 200 bits, and a 16 bit CRC, the probability that a user data frame is mistakenly treated by the discriminator 211 in the serving base station BS1 as a system control information frame is 2⁻¹⁶, which corresponds to one frame for every 1.6 MB of data exchanged. By using the methods of transmitting and receiving data frames according to the invention presented in FIG. 4A and FIG. 4B, wherein the modified first user data frame is retransmitted instead of the first user data frame, the probability that both the first user data frame and the modified first user data frame both are mistakenly treated by the discriminator 211 in the serving base station BS1 as system control information frames, is 2⁻³², which corresponds to once for every 107 GB of data exchanged.

Apart from the exemplary first embodiments of methods according to the invention disclosed above, there are several ways of providing rearrangements, modifications and substitutions resulting in additional embodiments of the invention.

Performing a cyclic one bit position left shift of the first user data is but one example of a bit pattern modifying function that can be used to produce a modified first user data frame from the first user data frame. The only restrictions on the bit pattern modifying function used is that it causes the modified first user data frame to have a different bit pattern than the first user data frame and that it is possible at the receiving end to recreate the original bit pattern of the first data frame by applying the inverse of the bit pattern modifying function. Thus the bit pattern modifying function applied to the first data frame may e.g. be a cyclic shift of multiple bit positions, a cyclic bit shift in the opposite direction or performing an exclusive-or operation with a bit mask.

There are several alternative ways of handling situations where a need for repeated retransmission of a user frame is detected. One alternative is to toggle between transmitting the original user frame and a modified version of said user frame. Thus, after transmitting the modified first user data frame at step 406 in FIG. 4A, the first user data frame could be transmitted once again if a need for retransmitting the first user data frame is detected a second time. Another alternative is to apply the bit pattern modifying function in a limited number of steps, e.g. 2-3, producing a first modified user data frame, a second modified user data frame etc and transmitting different modified versions of the user data frame each time a need for retransmitting the user data frame is detected.

The invention may be applied in different types of communication systems, not only communication systems adhering to the TIA/EIA-136 specifications. The basic requirement for being able to apply the methods for transmitting and receiving data frames according to the invention, is that an acknowledged mode of communication is used to communicate the data frames on a communication channel, i.e. data frames may be retransmitted, and that the data frames are subject to error detection, e.g. cyclic redundancy checks.

1. A method of transmitting data frames (S201) on a communication channel (DTC1) in a communication system (SYS1), the method comprising the steps of:
generating (401) a first data frame (S501);
transmitting (402) the first data frame (S501) on the communication channel (DTC1);
detecting (404) a need for retransmitting the first data frame (S501);
characterized in that the method further comprises the steps of:
generating (405) a modified first data frame (S502) by applying a predetermined bit pattern modifying function (F1) to the content of the first data frame (S501);
transmitting (406) the modified first data frame (S502) on the communication channel (DTC1),
wherein the modified first data frame (S502) is transmitted upon detecting (404) the need for retransmitting the first data frame (S501).

2. A method according to claim 1, wherein
said communication system (SYS1) comprises at least a first mobile station (MS1) and a radio communication network (NET1),
said communication channel is a bidirectional digital traffic channel (DTC1) established between the first mobile station (MS1) and the radio communication network (NET1),
said step of transmitting (402) the first data frame (S501) includes generating a first set of radio symbols from the first data frame (S501) and transmitting the first set of radio symbols on the bidirectional digital traffic channel (DTC1),
and said step of transmitting (406) the modified first data frame (S502) includes generating a second set of radio symbols from the modified first data frame (S502) and transmitting the second set of radio symbols on the bidirectional digital traffic channel (DTC1).

3. A method according to claim 2, wherein the transmitted data frames are user data frames (S201) and the bidirectional digital traffic channel (DTC1) is used for communicating both the user data frames (S201) and system control information frames (S202).

4. A method according to any one of claims 2-3, wherein the generating of the modified first data frame (S502) is performed upon detecting (404) the need for retransmitting the first data frame (S501).

5. A method according to any one of claims 2-4, wherein the generating of the first set of radio symbols from the first data frame (S501) and the generating of the second set of radio symbols from the modified first data frame (S502) include performing convolutional coding of the first data frame (S501) and the modified first data frame (S502) respectively.

6. A method according to any one of claims 1-5, wherein the predetermined bit pattern modifying function (F1) produces a cyclic one bit position shift of input data (S501) supplied to the function (F1).

7. A method according to any one of claims 1-6, wherein said step of detecting (404) the need for retransmitting the first data frame (S501) includes receiving (403) a receive status report and the need for retransmitting the first data frame (S501) is derived from the content of the receive status report.

8. A method for receiving data frames (S201) transmitted on a communication channel (DTC1) in a communication system (SYS1) according to any one of claims 1-7, the method comprising the steps of:
generating (410) a second data frame (S503) from signals received on the communication channel (DTC1);
performing (411) a first cyclic redundancy check of the second data frame (S503);
if the content of the second data frame (S503) passed the first cyclic redundancy check, then treating (413) the second data frame as a correctly received data frame (S201);
characterized in that the method further comprises the steps of:
if the content of the second data frame (S503) failed the first cyclic redundancy check, then performing the steps of producing (414) a modified second data frame (S504) by applying the inverse (F2) of the predetermined bit pattern modifying function (F1) to the second data frame (S503) and performing (415) a second cyclic redundancy check of the modified second data frame (S504);
if the content of the modified second data frame (S504) passed the second cyclic redundancy check, then treating (417) the modified second data frame (S504) as a correctly received data frame (S201).

9. A method according to claim 8, wherein said communication system (SYS1) comprises at least a first mobile station (MS1) and a radio communication network (NET1),
said communication channel is a bidirectional digital traffic channel (DTC1) established between the first mobile station (MS1) and the radio communication network (NET1),
and said step of generating (410) the second data frame (S503) includes generating (410) the second data frame from a set of radio symbols received on the bidirectional digital traffic channel (DTC1).

10. A method according to claim 9, wherein the received data frames are user data frames (S201) and the bidirectional digital traffic channel (DTC1) is used for communicating both the user data frames (S201) and system control information frames (S202).

11. A method according to any one of claims 8-10, wherein generating the second data frame (S503) from the received set of radio symbols includes performing convolutional decoding of data bits derived from the received set of radio symbols.
